(19) United States
(12) Patent Application Publication
(10) Pub. No.: US 2022/0346351 A1
(43) Pub. Date: Nov. 3, 2022

(54) HORSE COVERING USING MAGNETIC COUPLINGS

(71) Applicant: Jeanne SHIGO, Carversville, PA (US)

(72) Inventor: Jeanne SHIGO, Carversville, PA (US)

(21) Appl. No.: 17/733,938

(22) Filed: Apr. 29, 2022

Related U.S. Application Data
(60) Provisional application No. 63/182,040, filed on Apr. 30, 2021.

(51) Int. Cl. A01K 13/00; A01K 29/00

(52) U.S. Cl. CPC A01K 13/008; A01K 29/005; A41F 1/002

(57) ABSTRACT

A horse covering using magnetic couplers is shown and described. The horse covering includes a blanket portion, having a front end, a rear end, and two sides. A first strap is secured to the rear end of the blanket portion. The first strap includes a first part of a magnetic coupler secured to the end of the first strap opposite the connection to the blanket portion. A second end of the magnetic coupler is secured to the blanket portion. A second strap secured to the front end of the blanket portion. The second strap has a first part of a magnetic coupler secured to the end of the second strap opposite the connection to the blanket portion. A second end of the magnetic coupler is secured to the blanket portion. The horse covering further includes two front leg straps one secured to each side of the blanket portion.

### CROSS REFERENCE TO RELATED APPLICATIONS

This application claims the benefit of U.S. Provisional Application No. 63/182,040 filed on Apr. 30, 2021. The above identified patent application is herein incorporated by reference in its entirety to provide continuity of disclosure.

### BACKGROUND OF THE INVENTION

The present invention relates to horse coverings or blankets. More particularly, the present invention provides a horse covering which is secured to the horse using a plurality of magnetic securement devices. In some embodiments the horse covering further includes leg loops which help to better secure the covering to the horse.

There are many different types of horse coverings located on the market. These coverings have many different purposes however, they all have similar drawbacks. Each of these coverings use securement straps to secure the covering to the horse. Further, these belly straps are secured using a metal clasp. To compound the issue many of the belly straps are made of non-elastic materials.

The metal clasps have several drawbacks. First, they can become damaged from even simple wear. A horse could lay down crushing the clasp. This could make removing the covering extremely difficult. Further, the clasp would then have to be replaced. In some instances, this could lead to needing to replace the entire covering. These clasps could also lead to discomfort of the horse or worse injury.

The clasps may become rusty from the constant damp environment of being outside most of the time. This can lead to a weak strap which could splinter or break. This breakage will leave sharp ends which are dangerous to horses and trainers alike. Additional issues include mud and ice. When used in damp or cold environments, which is most of the time, the clasps may become caked with mud and/or ice. This will render the clasps inoperable.

Since many of the belly straps are non-elastic the horse will not have a great range of motion. When the horse moves the straps could tighten preventing motions. This tightening could also pull the clasps causing damage or worse rip the covering. In some efforts to overcome this issue the straps of a covering may not be adjusted when the covering is secured about a horse. This could lead to a loose covering which may slide from the horse. The straps may also loosen as a result of being pulled by the horse as it moves. Not only will loose straps cause a loose covering but a horse's leg may also become entrapped by the straps. This will lead to the complications above, or worse injury to the horse.

Consequently, there is a need for an improvement in the art of horse coverings. The present invention substantially diverges in design elements from the known art while at the same time solves a problem common in horse coverings. In this regard the present invention substantially fulfills these needs.

### SUMMARY OF THE INVENTION

The present invention provides a horse covering using magnetic couplers wherein the same can be utilized for providing convenience for the user when covering a horse with a blanket. The horse covering using magnetic couplers includes a blanket portion, having a front end, a rear end, and two sides. A first strap secured is to the rear end of the blanket portion. The first strap has a first part of a magnetic coupler secured to the end opposite the connection to the blanket portion. A second end of the magnetic coupler is secured to the blanket portion. A second strap secured to the front end of the blanket portion. The second strap has a first part of a magnetic coupler secured to the end opposite the connection to the blanket portion. A second end of the magnetic coupler is secured to the blanket portion.

Another object of the horse covering using magnetic couplers is to have the blanket portion be comprised of at least two layers.

Another object of the horse covering using magnetic couplers is to have one of the layers of the blanket portion be a water-resistant layer.

Another object of the horse covering using magnetic couplers is to have one of the layers of the blanket portion be a wool layer.

Another object of the horse covering using magnetic couplers is to have two front leg straps. Each leg strap is secured to a side of the blanket portion. Each leg strap has a first part of a magnetic coupler secured to the end opposite the connection to the blanket portion. A second end of the magnetic coupler is secured to the blanket portion.

Another object of the horse covering using magnetic couplers is to have the two front leg straps are made from a polypropylene.

Another object of the horse covering using magnetic couplers is to have the first half of the magnetic coupler includes a magnet located within a pocket of the respective strap and a pull tab secured to the pocket.

Another object of the horse covering using magnetic couplers is to have the first half of the magnetic coupler includes a magnet located within a pocket of the respective strap and a pull tab secured to the pocket.

Another object of the horse covering using magnetic couplers is to have the second half of the magnetic couplers are comprised of magnets having an opposite pole from the magnet if the first half, wherein the magnets are located within a pocket of the horse covering.

Another object of the horse covering using magnetic couplers is to have a neck portion removably secured to the front of the blanket portion.

Another object of the horse covering using magnetic couplers is to have the neck portion be horse hood, where the horse hood will cover a horse's neck and head.

Another object of the horse covering using magnetic couplers is to have an electrical component, where the electrical component reads vital signs.

Another object of the horse covering using magnetic couplers is to have the electrical component read at least temperature, heart rate, and oxygen levels.

Another object of the horse covering using magnetic couplers is to have the electrical component include GPS locator.

Another object of the horse covering using magnetic couplers is to have a wireless transceiver included within the electrical component.

Another object of the horse covering using magnetic couplers is to have the wireless transceiver will send vital signs to a designated device.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top-down view of an embodiment of the horse blanket with magnetic couplers.

FIG. 2 shows a perspective view of an embodiment of a horse in the horse blanket with magnetic couplers.

FIG. 3 shows a top-down view of an embodiment of the horse blanket with magnetic couplers including a removable neck portion.

FIG. 4 shows a perspective view of an embodiment of the horse blanket with magnetic couplers including a horse hood.

FIG. 5 shows a perspective view of an embodiment of the magnetic couplers for the horse blanket with magnetic couplers.

FIG. 6 shows a perspective view of an embodiment of the leg wraps for the horse blanket with magnetic couplers.

FIG. 7 shows a wiring diagram for an embodiment of the horse blanket with magnetic couplers.

LIST OF REFERENCE NUMERALS

| | |
|---|---|
| 100 | horse covering with magnetic couplers |
| 101 | blanket portion |
| 101a | rear end |
| 101b | front end |
| 101c | side |
| 101d | side |
| 101e | layers |
| 102 | first strap |
| 103 | first part of magnetic coupler |
| 104 | second part of magnetic coupler |
| 105 | second strap |
| 106 | first leg strap |
| 107 | second leg strap |
| 200 | horse |
| 301 | neck portion |
| 401 | horse hood |
| 401a | openings (for ears) |
| 401b | eye holes |
| 501 | pocket |
| 502 | pull tab |
| 503 | aperture |
| 504 | magnet |
| 700 | electric component |
| 701 | power source |
| 702 | GPS unit |
| 703 | wireless transceiver |
| 704 | heart rate sensor |
| 705 | temperature sensor |
| 706 | oxygen sensor |
| 707 | computing device |
| 708 | wireless transceiver |

With regard to the reference numerals used, the following numbering is used throughout the drawings.

### DETAILED DESCRIPTION OF THE INVENTION

Reference is made herein to the attached drawings. Like reference numerals are used throughout the drawings to depict like or similar elements of the horse covering using magnetic couplers. For the purposes of presenting a brief and clear description of the present invention, a preferred embodiment will be discussed as used for the horse covering using magnetic couplers. The figures are intended for representative purposes only and should not be considered to be limiting in any respect.

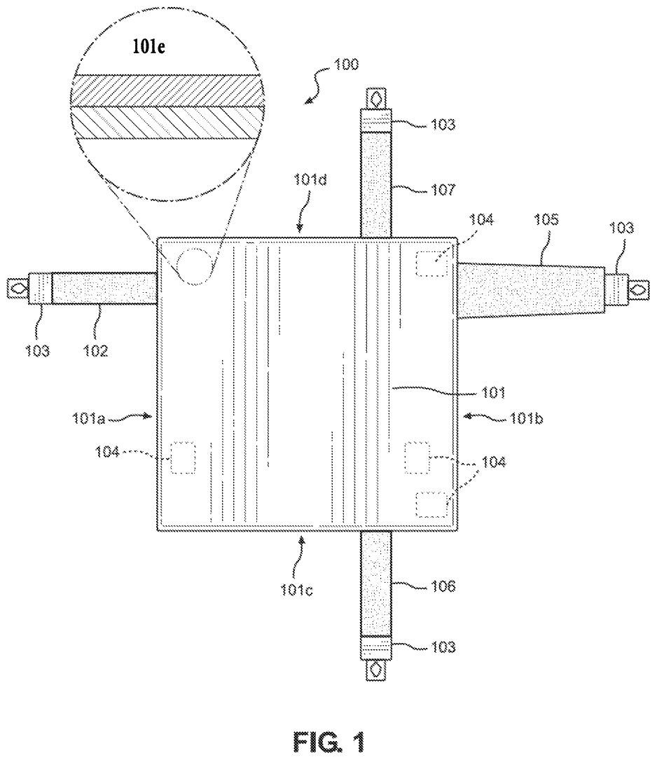

Referring now to FIG. 1, there is shown a top-down view of an embodiment of the horse blanket with magnetic couplers. The horse covering with magnetic couplers 100 is comprised of a blanket portion 101. In one embodiment the blanket portion 101 is rectangular. In other embodiments the blanket portion 101 is of other shapes which will fit a horse. The blanket portion 101 has a rear end 101a, a front end 101b, and two sides 101c, 101d.

In various embodiments the blanket portion 101 is comprised of multiple layers 101e. In one embodiment at least one of these layers is a wool layer. In another embodiment at least one of these layers is a cotton layer. In yet a further embodiment at least one of the layers is a waterproof layer. In one waterproof embodiment the material which makes up that layer is at least partially neoprene.

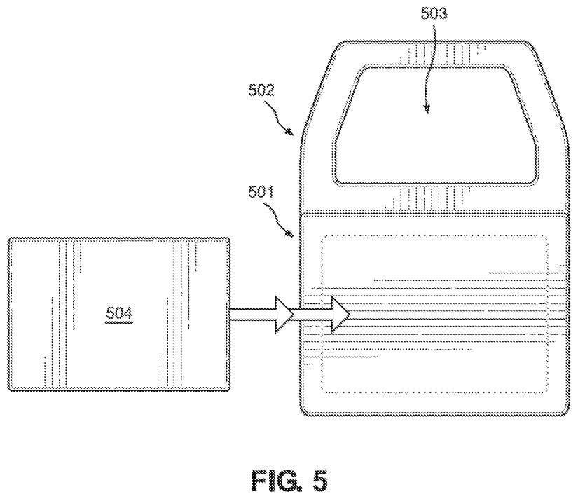

The blanket portion 101 further has multiple straps secured thereto. In one embodiment the blanket portion 101 has a first strap 102 secured to the rear end 101a of the blanket portion 101. In one embodiment the first strap 102 is secured near one side 101c of the blanket portion 101. The end of the first strap 102 opposite the end connected to the blanket portion 101 has a first part of a magnetic coupler 103 secured thereto. The first part of the magnetic coupler 103 will be discussed further in the description of FIG. 5. A second part of the magnetic coupler 104 is secured to the blanket portion 101. In one embodiment the second part of the magnetic coupler is secured to the blanket portion near the second side 101d of the blanket portion 101.

In one embodiment the blanket portion 101 has a second strap 105 secured to the front end 101b of the blanket portion 101. In one embodiment the second strap 105 is secured near one side 101c of the blanket portion 101. The end of the second strap 105 opposite the end connected to the blanket portion 101 has a first part of a magnetic coupler 103 secured thereto. The first part of the magnetic coupler 103 will be discussed further in the description of FIG. 5. A second part of the magnetic coupler 104 is secured to the blanket portion 101. In one embodiment the second part of the magnetic coupler 104 is secured to the blanket portion near the second side 101d of the blanket portion 101.

In one embodiment the blanket portion 101 has a first leg strap 106 secured to the one side 101c of the blanket portion 101. In one embodiment the first leg strap 106 is secured near the front 101b of the blanket portion 101. The end of the first leg strap 106 opposite the end connected to the blanket portion 101 has a first part of a magnetic coupler 103 secured thereto. The first part of the magnetic coupler 103 will be discussed further in the description of FIG. 5. A second part of the magnetic coupler 104 is secured to the blanket portion 101. In one embodiment the second part of the magnetic coupler 104 is secured to the blanket portion adjacent to the front 101b of the blanket portion 101.

In one embodiment the blanket portion 101 has a second leg strap 107 secured to the one side 101d of the blanket portion 101. In one embodiment the second leg strap 107 is secured near the front 101b of the blanket portion 101. The end of the second leg strap 101 opposite the end connected to the blanket portion 101 has a first part of a magnetic coupler 103 secured thereto. The first part of the magnetic coupler 103 will be discussed further in the description of FIG. 5. A second part of the magnetic coupler 104 is secured to the blanket portion 101. In one embodiment the second part of the magnetic coupler 104 is secured to the blanket portion adjacent to the front 101b of the blanket portion 101.

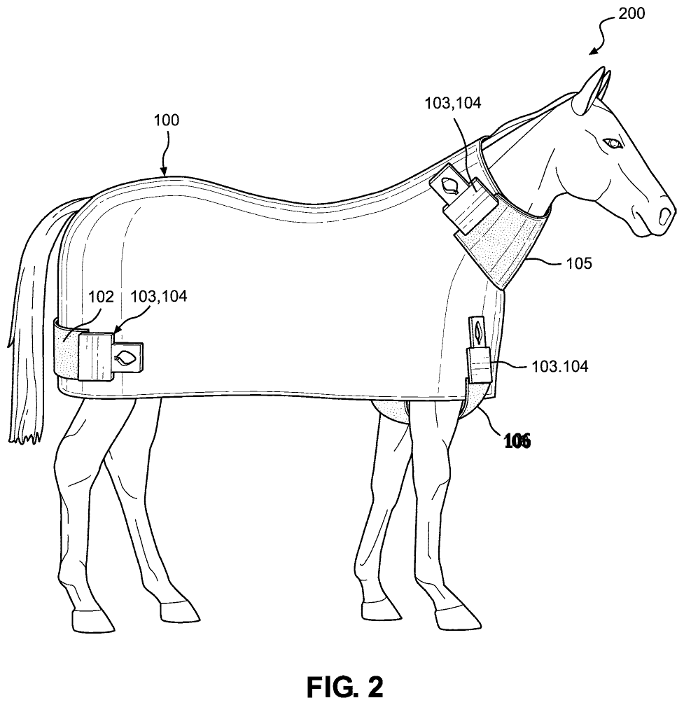

Referring now to FIG. 2, there is shown a perspective view of an embodiment of a horse in the horse blanket with magnetic couplers. When the horse covering with magnetic couplers 100 is placed about and secured to a horse 200 the first strap 102 will secure about the rump of the horse 200. The magnetic coupler 103, 104 will secure the first strap 102 ensuring the horse covering with magnetic couplers 100 does not pull forward and over the horse's 200 head.

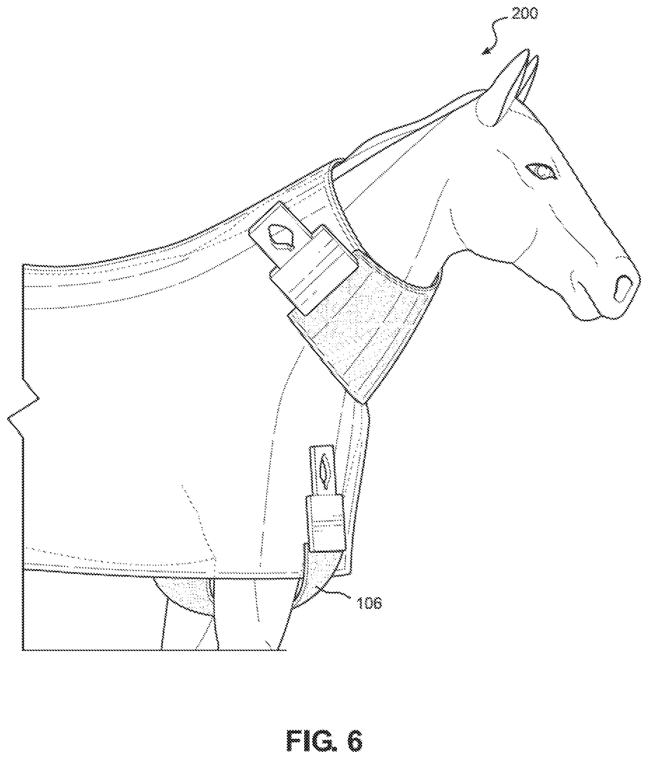

The second strap 105 is secured about the horse's 200 chest. The second strap is secured using the magnetic coupler 103, 104. The second strap 105 will prevent the horse covering with magnetic couplers 100 from sliding over the rear of the horse 200. The first leg strap 106 and the second leg strap are secured about to the horse's 200 front legs. The first leg strap 106 and the second leg strap will be discussed in more detail in FIG. 6. The first leg strap 106 and the second leg strap will prevent the horse covering with magnetic couplers 100 from sliding side to side on the horse 200.

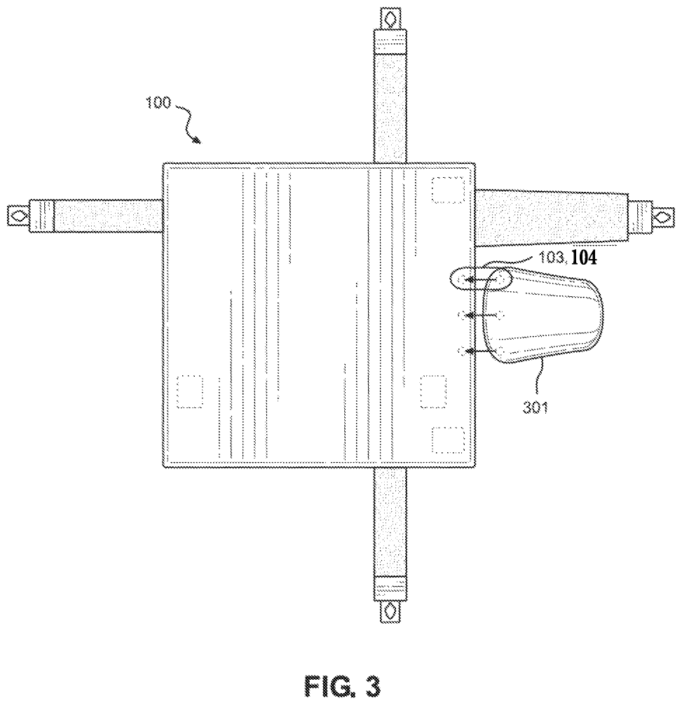

Referring now to FIG. 3, there is shown a top-down view of an embodiment of the horse blanket with magnetic couplers including a removable neck portion. In one embodiment a neck portion 301 is added to the horse covering with magnetic couplers 100. In one embodiment the neck portion 301 is removable. In another embodiment the neck portion 301 is secured to the horse covering with magnetic couplers 100. In yet another embodiment magnetic couplers 103, 104 are used to secure the neck portion 301 to the horse covering with magnetic couplers 100.

The neck portion 301 is configured to cover the horse's neck from the shoulder to just below the head. In one embodiment the neck portion 301 is a tube. In another embodiment additional magnetic couplers 103, 104 are used to allow for the neck portion 301 to be opened and closed about the horse.

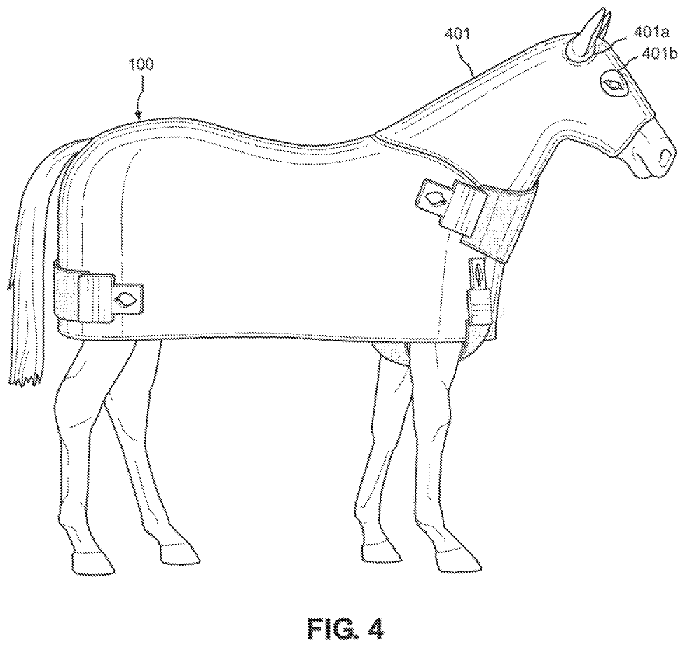

Referring now to FIG. 4, there is shown a perspective view of an embodiment of the horse blanket with magnetic couplers including a horse hood. In one embodiment a horse hood 401 is added to the horse covering with magnetic couplers 100. In one embodiment the horse hood 401 is removable. In another embodiment the horse hood 401 is secured to the horse covering with magnetic couplers 100. In yet another embodiment magnetic couplers are used to secure the horse hood 401 to the horse covering with magnetic couplers 100. In one embodiment the horse hood is fixed to the horse covering with magnetic couplers 100.

The horse hood 401 is configured to cover the horse's neck and head from the shoulder to just behind the nose and mouth. The horse hood 401 has openings 401a for the horse's ears to poke through. Further, the horse hood 401 will have eye holes 401b such that the horse may see through the hood 401. In one embodiment the horse hood 401 is a tube. In another embodiment additional magnetic couplers are used to allow for the horse hood 401 to be opened and closed about the horse.

Referring now to FIG. 5, there is shown a perspective view of an embodiment of the magnetic couplers for the horse blanket with magnetic couplers. In one embodiment one half of the magnetic coupler 103 is made up of a pocket 501 and a pull tab 502. The pocket 501 is configured to have a magnet 504 therein. In one embodiment the magnet 504 has one pole. A magnet sown into the blanket portion will have an opposite pole. This will ensure that the magnets will secure together securing the coupler. The pocket 501 shall be made of a material which is tear resistant and strong enough that the material will not rip leaving the magnet 504 secured to the blanket portion.

The pull tab 502 is secured to the pocket 501. This will allow a user to have a firm handle to separate the magnetic coupler. In one embodiment the pull tab 502 includes an aperture 503. This will ensure the pull tab 502 will enable a grasp which is strong enough to separate the magnetic coupler.

Referring now to FIG. 6, there is shown a perspective view of an embodiment of the leg wraps for the horse blanket with magnetic couplers. Here there is shown one leg strap 106. The leg strap 106 will wrap around the horse's 200 leg and under the chest. The leg strap 106 will then come out the other side and secure to the blanket portion 101. In one embodiment the leg straps 106 are made from a flexible material. In another embodiment the leg straps 106 are made from an elastic material. In one embodiment the leg straps are made from a polypropylene similar to that of a trampoline mat. This will allow the horse to move about freely while still ensuring the blanket is secured in place about the horse.

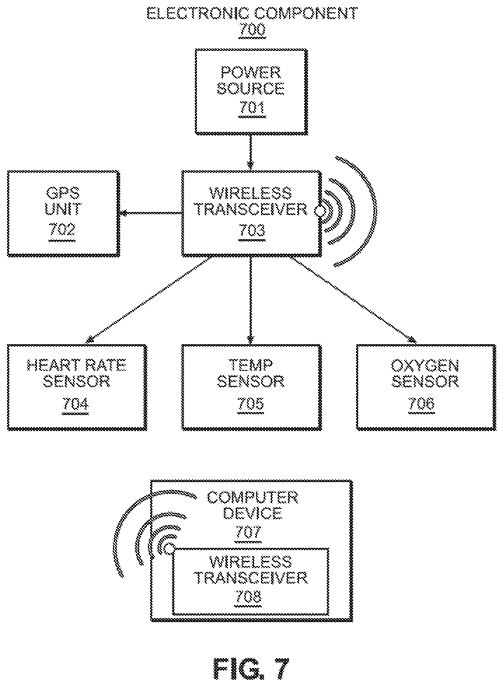

Referring now to FIG. 7, there is shown a wiring diagram for an embodiment of the horse blanket with magnetic couplers. In various embodiments the horse blanket with magnetic couplers includes an electronic component 700. In different embodiments the electric component 700 will have different components. In one embodiment the electronic device 700 will include a power source 701. The power source 701 will be coupled to any number of additional parts and sensors. In the shown embodiment the power source is connected to a GPS unit 702. The GPS unit is then coupled to a wireless transceiver 703.

In other embodiments the electronic component further includes a heart rate sensor 704, a temperature sensor 705, and an oxygen sensor 706. In the shown embodiment these sensors are coupled to the wireless transceiver 703. In other embodiments different sensors or a different combination of sensors are used.

In one embodiment the wireless transceiver 703 is configured to transmit data to a computing device 707. The computing device 707 will include a wireless transceiver 708 such that it may receive the data. The computing device is used to allow an individual to monitor a horse. in some embodiments a special program may be used to monitor the horse. This program may include the ability to track the horse via GPS. In another embodiment the program will allow the user to set alarms in case the horse's vital drop or raise to specified levels.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A horse covering using magnetic couplers, the horse covering comprises:
a blanket portion, having a front end and rear end and two sides;
a first strap secured to the rear end of the blanket portion;
the first strap has a first part of a magnetic coupler secured to the end opposite the connection to the blanket portion;
a second end of the magnetic coupler is secured to the blanket portion;
a second strap secured to the front end of the blanket portion.
the second strap has a first part of a magnetic coupler secured to the end opposite the connection to the blanket portion;
a second end of the magnetic coupler is secured to the blanket portion.

2. The horse covering using magnetic couplers of claim 1, wherein the blanket portion is comprised of at least two layers.

3. The horse covering using magnetic couplers of claim 2, wherein one of the layers of the blanket portion is a water-resistant layer.

4. The horse covering using magnetic couplers of claim 2, wherein one of the layers of the blanket portion is a wool layer.

5. The horse covering using magnetic couplers of claim 1, further comprising two front leg straps;
wherein each leg strap is secured to a side of the blanked portion;
each leg strap has a first part of a magnetic coupler secured to the end opposite the connection to the blanket portion;
a second end of the magnetic coupler is secured to the blanket portion.

6. The horse covering using magnetic couplers of claim 5, wherein the two front leg straps are made from a polypropylene.

7. The horse covering using magnetic couplers of claim 1, wherein the first half of the magnetic coupler includes a magnet located within a pocket of the respective strap and a pull tab secured to the pocket.

8. The horse covering using magnetic couplers of claim 4, wherein the first half of the magnetic coupler includes a magnet located within a pocket of the respective strap and a pull tab secured to the pocket.

9. The horse covering using magnetic couplers of claim 7, wherein the second half of the magnetic couplers are comprised of magnets having an opposite pole from the magnet if the first half, wherein the magnets are located within a pocket of the horse covering.

10. The horse covering using magnetic couplers of claim 1, further comprising a neck portion is removably secured to the front of the blanket portion.

11. The horse covering using magnetic couplers of claim 10, wherein the neck portion is a horse hood, the horse hood will cover a horse's neck and head.

12. The horse covering using magnetic couplers of claim 1, further comprising an electrical component, where the electrical component reads vital signs.

13. The horse covering using magnetic couplers of claim 12, wherein the electrical component reads at least temperature, heart rate, and oxygen levels.

14. The horse covering using magnetic couplers of claim 12, where the electrical component includes GPS locator.

15. The horse covering using magnetic couplers of claim 12, further comprising a wireless transceiver.

16. The horse covering using magnetic couplers of claim 15, wherein the wireless transceiver will send vital signs to a designated device.
